(19) United States
(12) Patent Application Publication
(10) Pub. No.: US 2013/0054731 A1
(43) Pub. Date: Feb. 28, 2013

(54) CUT/COPY AND PASTE FUNCTIONALITY

(71) Applicant: Paul Keith BRANTON, Rochdale (GB)

(72) Inventor: Paul Keith BRANTON, Rochdale (GB)

(73) Assignee: AppSense, Limited, Warrington (GB)

(21) Appl. No.: 13/531,153

(22) Filed: Jun. 22, 2012

(30) Foreign Application Priority Data
Jun. 24, 2011 (GB) 1110769.5

(51) Int. Cl. G06F 15/16; G06F 15/167

(52) U.S. Cl. 709/213; 709/217

(57) ABSTRACT

An apparatus including a clipboard monitor at a first device is described. The clipboard monitor is operatively coupled to a data management module. The clipboard monitor is configured to receive metadata associated with data acquired in an acquire operation at the first device. The clipboard monitor is configured to send the metadata to the data management module in response to the acquire operation. The clipboard monitor is configured to receive a request associated with a paste operation at a second device. The clipboard monitor is configured to provide the data to the second device in response to the request.

### CROSS-REFERENCE TO RELATED APPLICATION

This application claims priority to and the benefit of United Kingdom patent application no. GB 1110769.5, filed Jun. 24, 2011, and entitled “Improvements in and Relating to Cut/Copy and Paste Functionality,” which is incorporated herein by reference in its entirety.

### FIELD OF THE INVENTION

The present invention relates to devices, systems and methods for use in cut/copy and paste operations.

### BACKGROUND

Cut and paste or copy and paste have become ubiquitous features of many applications, including, but not limited to, many spreadsheet, word processing, presentation and publishing applications. For purposes of the embodiments described herein, there is no particular difference between the handling of a copy operation and a cut operation; hence they will collectively be referred to herein as an “acquire” operation.

It would be desirable to have a system and method suitable to achieve an acquire and paste operation between devices, real or virtual, with minimal computational effort and impact to users.

A need exists for an improved acquire and paste system and method.

### SUMMARY

In some embodiments, an apparatus includes a clipboard monitor at a first device. The clipboard monitor is operatively coupled to a data management module. The clipboard monitor is configured to receive metadata associated with data acquired in an acquire operation at the first device. The clipboard monitor is configured to send the metadata to the data management module in response to the acquire operation. The clipboard monitor is configured to receive a request associated with a paste operation at a second device. The clipboard monitor is configured to provide the data to the second device in response to the request.

### BRIEF DESCRIPTION OF THE DRAWINGS

FIG. 1 is a schematic illustration of a system configured to execute an acquire and paste operation, according to an embodiment.

FIG. 2A is a schematic illustration of an initialization operation performed by the system of FIG. 1, according to an embodiment.

FIG. 2B is a schematic illustration of an acquire operation performed by the system of FIG. 1, according to an embodiment.

FIG. 2C is a schematic illustration of a paste operation performed by the system of FIG. 1, according to an embodiment.

FIG. 3 illustrates part of the method of operation of the system of FIG. 1, in this case the append operation phase, according to an embodiment.

### DETAILED DESCRIPTION

Various aspects and features according to exemplary embodiments are described hereinafter with reference to sequence illustrations of user interfaces, methods, and computer program products. It will be understood that each sequence and combinations of sequences in the illustrations can be implemented by, for example, computer program instructions. These computer program instructions can be provided to, for example, a processor of a general purpose computer, a special purpose computer, or other programmable data processing apparatus to produce a machine, such that the instructions, which are executed at the processor of the computer or other programmable data processing apparatus, can create means for implementing the functions specified in the sequence.

These computer program instructions may also be stored in, for example, a computer usable or computer-readable memory that can direct a computer or other programmable data processing apparatus to function in a particular manner, such that the instructions stored in the computer usable or computer-readable memory can produce an article of manufacture including instructions that can be used to implement the function specified in the sequence.

The computer program instructions may also be loaded onto, for example, a computer or other programmable data processing apparatus to cause a series of operational steps to be performed on the computer or other programmable apparatus to produce a computer implemented process, such that the instructions executed at the computer or other programmable apparatus can provide steps for implementing the functions specified in the sequence.

Furthermore, each sequence may represent a module, segment, or portion of code, which includes one or more executable instructions for implementing the specified logical function(s). It should also be noted that in some alternative implementations, the functions noted in the sequence may occur out of the order described herein. For example, two sequences shown in succession herein may in fact be executed substantially concurrently or the two sequences may sometimes be executed in the reverse order, depending upon the functionality involved.

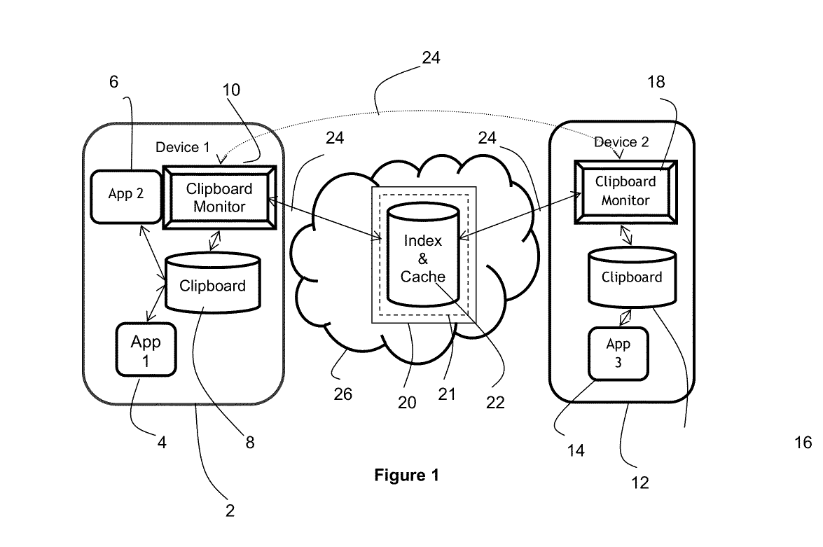

FIG. 1 is a schematic illustration of a system configured to execute an acquire and paste operation, according to an embodiment. Specifically, the system can be configured to operate a data transfer operation between a first device 2 (identified as “Device 1” in FIG. 1) and a second device 12 (identified as “Device 2” in FIG. 1). The system includes the first device 2, which can be in the form of, for example, a computational apparatus running a first application 4 (identified as “App 1” in FIG. 1) and a second application 6 (identified as “App 2” in FIG. 1). The first device 2 also includes a clipboard 8 and a clipboard monitor 10.

The system also includes the second device 12, which can be in the form of, for example, a computational apparatus running a third application 14 (identified as “App 3” in FIG. 1). The second device 12 further includes a clipboard 16 and a clipboard monitor 18.

In some embodiments, the first application 4, the second application 6 and the third application 14 can be any application that enables an acquire and/or paste operation, such as, for example, Microsoft WORD (trade mark), Microsoft EXCEL (trade mark), Notepad (trade mark), a web browser application, and/or the like. In some embodiments, instructions associated with the first application 4, the second application 6 and/or the clipboard monitor 10 can be stored in a memory (not shown in FIG. 1) of the first device 2 and/or executed at a processor (not shown in FIG. 1) of the first device 2. The clipboard 8 can be included within a portion of a memory at the first device 2. Similarly, in some embodiments, instructions associated with the third application 14 and/or the clipboard monitor 18 can be stored in a memory (not shown in FIG. 1) of the second device 12 and/or executed at a processor (not shown in FIG. 1) of the second device 12. The clipboard 16 can be included within a portion of a memory at the second device 12.

The system further includes a third device 20 in the form of, for example, a computational apparatus including a data management module 21. The data management module 21 is configured to maintain and manage an index file and a cache (stored in a database 22) at the third device 20. In some embodiments, the data management module 21 can be executed within a memory (not shown in FIG. 1) and/or a processor (not shown in FIG. 1) of the third device 20. For example, in some embodiments, instructions associated with the data management module 21 can be stored in a memory and/or executed at a processor of the third device 20. In some embodiments, the third device 20 can be, for example, a cloud-based server device, as indicated schematically by the cloud-based device 26 in FIG. 1.

The first device 2, the second device 12 and the third device 20 are operatively coupled to each other, as indicated schematically by arrows 24 in FIG. 1. In some embodiments, the first device 2, the second device 12 and the third device 20 can be interconnected via one or more networks such as, for example, the Internet, a wireless area network (WAN), a local area network (LAN), a cellular network, a Wi-Fi network, and/or any other suitable networks.

In some embodiments, each device that can operate an acquire or paste operation in the system (e.g., the first device 2, the second device 12) includes a clipboard monitor (e.g., the clipboard monitor 10 for the first device 2, the clipboard monitor 18 for the second device 12). Such a clipboard monitor (10 or 18) of a device (2 or 12) functions as a single application to monitor operations at a corresponding clipboard (8 or 16) of that device (2 or 12). Each clipboard monitor (10 or 18) is also configured to store the location of the third device 20, which functions as a shared data store in the system and is available to each device (2 or 12) that shares its clipboard (8 or 16) with the remaining devices in the system. The third device 20 is used to store the index of available formats and/or cached copies of data as described below.

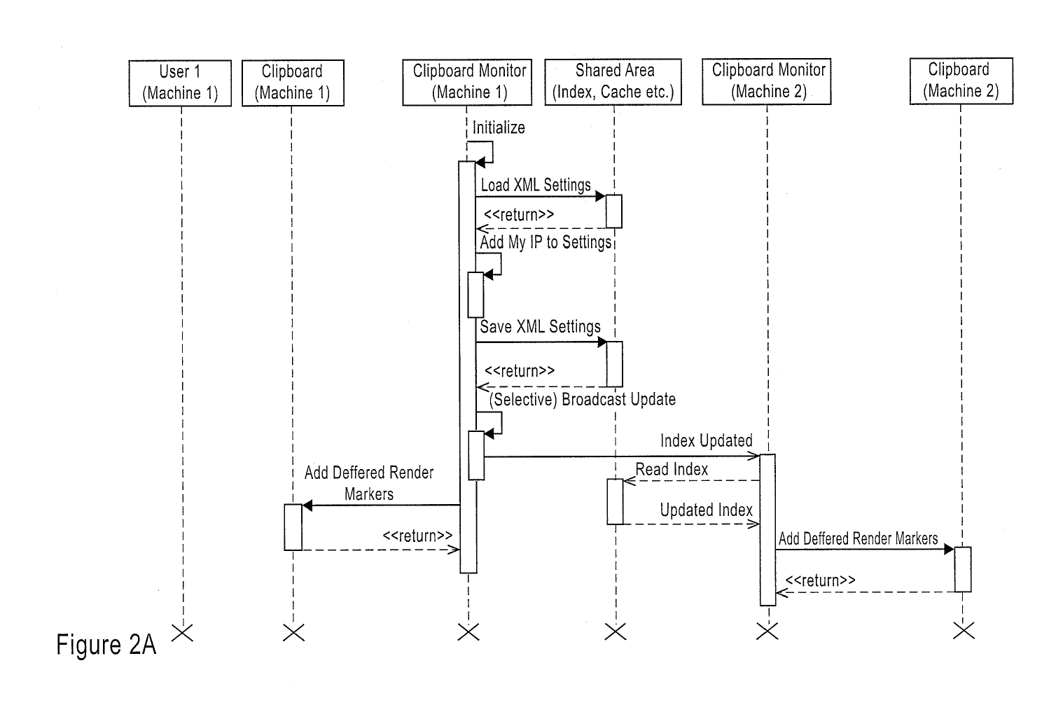

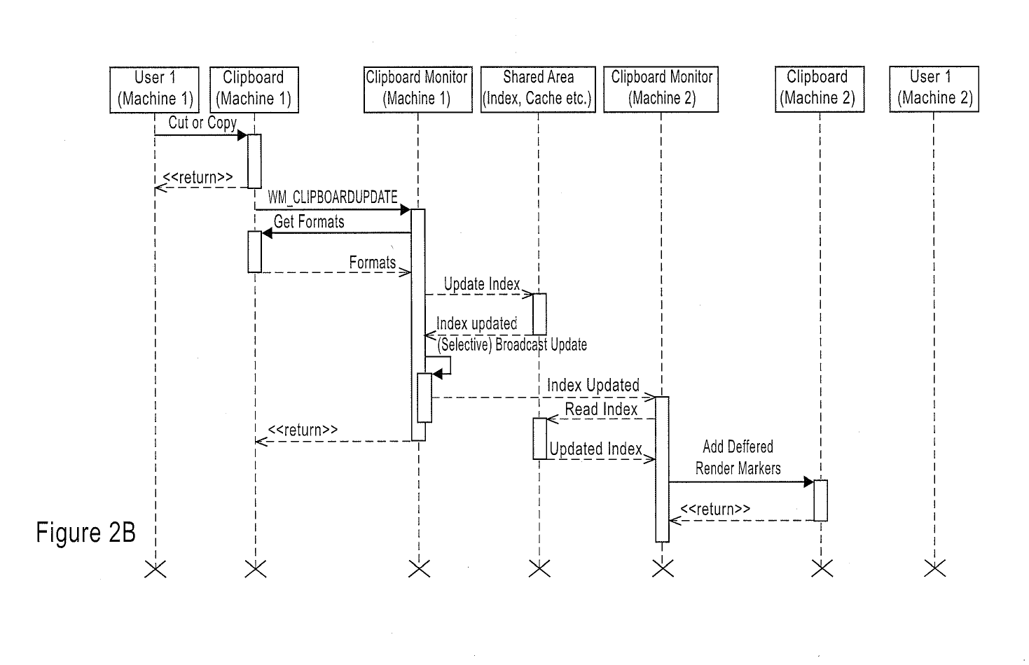

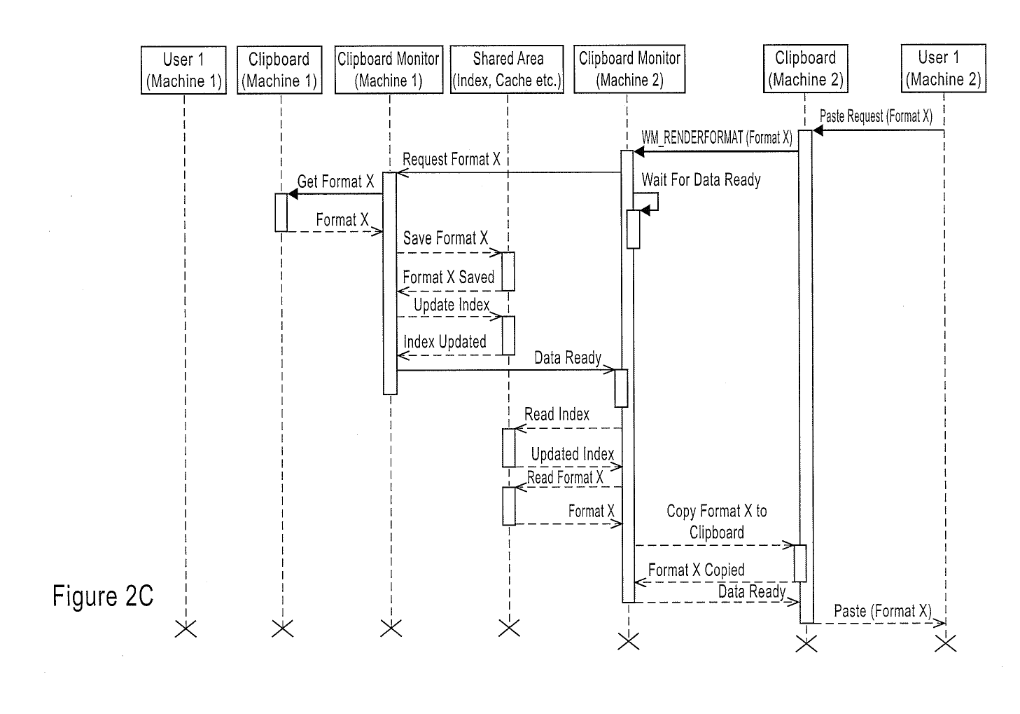

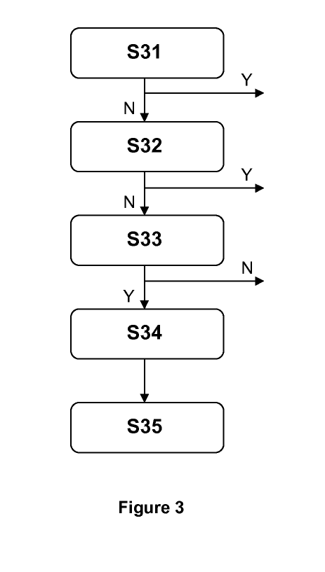

The operations of the system shown and described with respect to FIG. 1 are shown in FIGS. 2A, 2B, 2C and 3, and described in detail below.

FIG. 2A is a schematic illustration of an initialization operation performed by the system of FIG. 1, according to an embodiment. Specifically, when the clipboard monitor 10 is initialized, the clipboard monitor 10 is configured to send its location information (e.g., an Internet protocol (IP) address, a domain name system (DNS) name, etc.) to the index file at the data management module 21 on the third device 20. Any other devices using the same index file (which have previously sent their location information to the index file) are notified by the clipboard monitor 10 that the clipboard monitor 10 at the first device 2 has been added to the index file. Thus, each clipboard monitor (e.g., the clipboard monitor 18 on the second device 12) is aware of each remaining clipboard monitor using the same index file and cache at the third device 20.

In some embodiments, deferred data markers are used in the system as metadata to indicate the location information and the format(s) of data available for a paste operation from a device in the system. Such metadata (e.g., deferred data markers) is stored at the third device 20 that is accessible to other devices (e.g., the first device 2, the second device 12) that are sharing their clipboard in the system. Thus, the metadata can be shared by those other devices. For example, metadata indicating the location information of the first device 2 and the format(s) of data available at the first device 2 can be stored at the data management module 21 of the third device 20. When a paste operation is instructed on the second device 12, the clipboard monitor 18 is configured to check whether the data to be pasted is available in the requested format at the third device 20 (the data may have been stored in the cache at the third device 20 as a result of an earlier paste operation for the second device 12 or another device). If the data is available in the requested format at the third device 20, the data management module 21 is configured to send the data to the second device 12. Otherwise, if the data is not available in the requested format at the third device 20, the clipboard monitor 18 of the second device 12 is configured to request the data from the first device 2. In response to the request, the clipboard monitor 10 of the first device 2 is configured to provide the data in the requested format from the first device 2 to the third device 20, which is then configured to transfer the data in the requested format to the second device 12. Additionally, any new data fetched in this way is stored in the cache of the third device 20, and the index file at the data management module 21 is updated accordingly to show that the data is cached.

FIG. 2B is a schematic illustration of an acquire operation performed by the system of FIG. 1, according to an embodiment. Specifically, a user operating the first device 2 initiates an acquire operation to acquire (e.g., copy, cut) a portion of data (e.g., text, pictures, formulae, etc.) that is captured by the clipboard 8. The acquire operation is then detected by the clipboard monitor 10, which recognizes an update of the clipboard 8. The clipboard monitor 10 is configured to identify the format(s) in which the data is available for pasting from the clipboard 8. In some embodiments, for example, the clipboard monitor 10 uses a Win32 application programming interface (API) call to enumerate the available format(s) present on the clipboard 8. In other embodiments, the clipboard monitor 10 can use any other suitable interface mechanisms to obtain information associated with the available format(s) at the clipboard 8. Additionally, in some embodiments, the clipboard monitor 10 can be configured to perform a self-feeding check to ensure that the clipboard monitor 10 has not itself added any data to the clipboard 8 or where the clipboard monitor 10 has added any data, the source of this addition of data is recognized as the clipboard monitor 10. This can be done by, for example, adding an operation marker such as an additional custom registered format to the format(s) of data identified at the clipboard monitor 10.

The clipboard monitor 10 is then configured to communicate (e.g., over the network connecting the first device 2 and the third device 20) with the data management module 21 of the third device 20 to send the metadata regarding the acquired data to the data management module 21. The data management module 21 is configured to update the index file at the data management module 21 with the metadata.

In some embodiments, the metadata can be stored in two sections (a formats section and a sources section) in the index file at the data management module 21. In some embodiments, the formats section contains a list of entries (e.g., “ClipDatum”) that each contains a name (e.g., “UnicodeText”, “OEMText”, etc.) and/or a state of a format. In some embodiments, each entry of the format section can include, for example, a globally unique identifier (GUID). The GUID can uniquely identify a source of the data (i.e., the device that added the format to the index file). In some embodiments, an empty GUID, a GUID with all zeros, or a GUID in some other predetermined format can be used to indicate the data is stored in the cache at the data management module 21 of the third device 20. In some embodiments, the index file at the data management module 21 may also store the operation marker.

The sources section contains a list of entries (e.g., “UDPGuid”) that each contains an address (e.g., an IP address) and the GUID associated with a source of the data (e.g., the device that added the metadata of the data to the index file). The GUID contained in the sources section matches at least one GUID contained in the formats section. Additionally, each GUID can be uniquely associated with a particular device. In some embodiments, for example, the GUID for a particular device is created once when the initialization operation for the clipboard monitor of that device starts, and is not changed afterwards.

For example, the index file stored in the data management module 21 can be in the format of extensible markup language (XML) as follows.

```
    <ClipData xmlns:xsi=“http://www.w3.org/2001/XMLSchema-
instance” xmlns:xsd=“http://www.w3.org/2001/XMLSchema”>
    <Formats>
      <ClipDatum>
      <Name>UnicodeText</Name>
      <State>6577b7d7-504c-4432-8791-3a354ed3fa19</State>
      </ClipDatum>
      <ClipDatum>
      <Name>Locale</Name>
      <State>6577b7d7-504c-4432-8791-3a354ed3fa19</State>
      </ClipDatum>
      <ClipDatum>
      <Name>Text</Name>
      <State>6577b7d7-504c-4432-8791-3a354ed3fa19</State>
      </ClipDatum>
      <ClipDatum>
      <Name>OEMText</Name>
      <State>00000000-0000-0000-0000-000000000000</State>
      </ClipDatum>
    </Formats>
    <Sources>
      <UDPGuid>
      <IP>10.0.8.87</IP>
      <Owner>6577b7d7-504c-4432-8791-3a354ed3fa19</Owner>
      </UDPGuid>
    </Sources>
```

In the example above, the data is available at the first device 2 in the formats of “UnicodeText”, “Locale”, “Text” and “OEMText”; the data is stored in the format of “OEMText”, but not any other format, in the cache at the data management module 21 (because the state for the format “OEMText” is in the form of all zeros); the source of the data has a GUID “6577b7d7-504c-4432-8791-3a354ed3fa19” and an IP address “10.0.8.87”.

After the index file at the data management module 21 is updated with the metadata, the data management module 21 can be configured to broadcast the updated index file to the devices known to the data management module 21 that are using the index file (e.g., the first device 2, the second device 12). Alternatively, the data management module 21 can be configured to broadcast an indication that the index file is updated to those devices. In response to receiving such an indication, each of the devices can be configured to read the updated index file from the data management module 21 at the third device 20.

After the updated index file is received at the second device 12, the clipboard monitor 18 of the second device 12 can be configured to update the clipboard 16 of the second device 12 with the metadata (e.g., the deferred render markers) associated with the acquire operation.

FIG. 2C is a schematic illustration of a paste operation performed by the system of FIG. 1, according to an embodiment. Specifically, when a user (typically but not necessarily the same user initiates the acquire operation) operating the second device 12 instructs a paste operation in a given format (e.g., pasting text from WORD (trade mark) into an EXCEL (trade mark) spreadsheet) at the second device 12, the clipboard monitor 18 of the second device 12 detects the requested paste operation and then checks whether the data is cached in the requested format at the data management module 21 of the third device 20. For example, the clipboard monitor 18 can be configured to check whether the state of the requested format stored in the index file is empty (or all zeros). If the state of the requested format is empty, the data is known to be cached at the data management module 21 on the third device 20. In such a case, the clipboard monitor 18 is configured to send a request for the cached data to the data management module 21. In response to the request, the data management module 21 is configured to send the data in the requested format to the clipboard monitor 18, which can be configured to send the data to the clipboard 16. The paste operation can be completed using the clipboard 16.

In some embodiments, the clipboard monitor 18 can be configured to determine the requested format based on information of the settings associated with the application in which the paste operation is being carried out.

In an embodiment of the present invention, there is also provided a method and a device configured to perform an append operation whereby requested data and previously requested data are appended to generate new operated data when a paste operation is requested at the second device 12. In this embodiment, the append operation is provided as a form of the paste operation. The user may instruct an append operation by setting a modifier to be active then instructing the paste operation. The modifier is set active by holding down a modifier key assigned by the user. The modifier key might be a right control key or a function key. Although not described in this embodiment, any other input devices or methods and combinations or sequences of keys are usable for setting the modifier as active.

Referring to FIG. 3 of the accompanying drawings, the append operation of the system will now be explained.

The clipboard monitor 18 of the second device 12 is configured to amend the data copied to the clipboard 16 of the second device 12 when requested. In this embodiment, the amendment to the data is an append operation. However, any other data to data manipulation may be implemented using the same method of operation described herein. The paste operation includes the append operation and the append operation is instructed by setting the modifier to be active before instructing the paste operation. In another embodiment, the append operation may be separate from the paste operation but the method of operation will still be similar to what is described herein.

In this embodiment, when the append operation is performed the paste operation terminates once the append operation has terminated without the actual pasting of the amended data outside the clipboard 16 of the second device 12.

The clipboard monitor 18 of the second device 12 monitors any new data being copied to the clipboard 16 of the second device 12. The monitoring may includes a message being sent to the clipboard monitor 18 whenever a new data is copied to the clipboard 16 or detecting a change in a clipboard count wherein the clipboard count is maintained by the clipboard 16 and the clipboard count changes each time data is copied to the clipboard 16. It is expected that the former method will be compatible with a standard clipboard 16 running on Windows (trade mark) and the latter on iOS (trade mark) or Mac OS (trade mark).

When the new data is copied, the clipboard monitor 18 stores the new data copied to the clipboard 16 to a cache or a storage medium on the second device 12 so that the stored data is usable as a previous data for the next new data to be copied. The clipboard monitor 18 determines whether this is the first paste operation or not (S31) by checking the cache, the storage medium or the clipboard 16 for any previous data. If there is no previous data, this is the first paste operation and hence the append operation is deemed not possible and the normal paste operation continues. If there is previous data, the clipboard monitor 18 also determines if the new data includes an operation marker (S32). If the operation marker is present, the new data remains as it is in the clipboard 16 and the clipboard monitor 18 recognizes the new data as an already operated data which may have been added by the clipboard monitor 18 itself.

In another embodiment, when the new data is about to be copied, the clipboard monitor 18 determines whether this is the first paste operation or not (S31) and, if it is not, stores the previous data in the clipboard 16 to a cache or a storage medium of the second device 12 and determines if the new data includes an operation marker (S32). If the operation marker is present, the new data is copied to the clipboard 16 replacing the previous data. The replacement of the previous data may includes removing the previous data from the clipboard 16, then copying the new data to the clipboard 16 in the case of the clipboard 16 running on, for example, iOS® or Mac®.

If the operation marker is not present, the clipboard monitor 18 determines whether the modifier is active or not (S33). The modifier is determined to be active if the modifier input is received prior to or during the paste operation.

If the modifier is determined to be inactive, the new data remains as it is in the clipboard 16 and the operation is determined to be a normal paste operation and the normal paste operation continues. If the modifier is determined to be active, the operation is determined to be an append operation and the clipboard monitor 18 stores the new data to the cache or the storage medium of the second device 12. The clipboard monitor 18 then retrieves the previously stored previous data and the new data from the cache, the storage medium or the clipboard 16 and performs an append operation to create an operated data (S34). The append operation includes appending the new data and the previous data to generate the operated data. The clipboard monitor 18 may also add the operation marker to the operated data thereafter (S35).

The clipboard monitor 18 stores the operated data to the cache or the storage medium on the second device 12 so that the previous data is replaced with the operated data. This ensures that the operated data is available as the previous data for the next append operation if there is one. The clipboard monitor 18 also copies the operated data to the clipboard 16. As the operated data includes the operation marker, this addition of the operated data does not trigger the clipboard monitor 18 to perform another operation. Therefore the operated data is in the clipboard 16, available for the next paste operation.

In an alternative embodiment, the clipboard monitor 18 does not determine the presence of the operation marker (S32) and proceeds to determining whether the modifier is active or not (S33). In such an embodiment, if the modifier is determined to be active, the clipboard monitor 18 sets an operation marker in the cache or the storage medium of the second device 12 so that when the operated data generated from the append operation is copied to the clipboard 16, the modifier is determined to be inactive regardless of the modifier input, whereby the addition of the operated data is prevented from triggering the clipboard monitor 18 to perform another operation.

The clipboard monitor 18 also obtains metadata regarding the operated data and transmits the metadata to a third device 20. Upon request the clipboard monitor 18 provides the operated data associated with the metadata to the third device 20.

The clipboard monitor 18 may also provide the operated data upon receipt of a request from any device. The request may be from the first device 2 or from any other device including a clipboard monitor configured to obtain the metadata regarding the operated data from the data management module 21 of the third device 20.

The append and paste operations may terminate thereafter until a new request is made by the user.

In another embodiment, the third device 20 is also configured to perform the append operation as described above. In this embodiment, the data management module 21 is configured to perform some of the functions of the second clipboard monitor 18 of the second device 12 described above. The metadata stored in the index 22 at the data management module 21 of the third device 20 may also include an operation marker where added. When the cached data is available on the index and cache 22 of the third device 20, an operation marker may be added to the cached data.

On receiving a paste request from the second device 12, the data management module 21 determines whether this is the first paste operation on the requested data or not (S31) and, if it is not, determines if the requested data's metadata, or cached data if available, includes an operation marker (S32). The data management module 21 may make the first paste operation determination by determining if the metadata or the cached data is available or by just searching through the index 22.

The request from the second device 12 includes information on the determination of whether a modifier is active on the second device 12 (S33). Using the operation marker determination from the metadata or the cached data and the modifier determination from the second device 12, the data management module 21 determines whether an append operation has been instructed by the user (S32 and S33). If the append operation has been instructed, the data management module 21 performs the append operation to generate a metadata for an operated data and caches the operated data if cached versions of the data were also available (S34). The data management module 21 also adds the operation marker to the operated data thereafter (S35). As the operated data includes the operation marker, any copying of the operated data to other clipboards such as the clipboard 16 on the second device 12 does not trigger the device's clipboard monitor 18 to perform another operation. Therefore the operated data is copyable to the clipboard 16 of the requested second device 12, available for the next paste operation, without any additional unwanted triggering of further append operations.

In an alternative embodiment, the data management module 21 does not determine the presence of the operation marker (S32) and proceeds to determining whether the modifier is active or not (S33). In such an embodiment, if the modifier is determined to be active, the data management module 21 sets an operation marker in the metadata of the operated data after the append operation, updates the index of metadata accordingly and transmits the updated index to the second device 12. The second device 12 then stores the operation marker in a cache or a storage medium of the second device 12 and when copying the operated data to the clipboard 16, the clipboard monitor 18 of the second device 12 determines the modifier to be inactive regardless of the modifier input, whereby the addition of the operated data is prevented from triggering the clipboard monitor 18 of the second device 12 to perform any further append operations.

The third device 20 is also configured to update the metadata for the operated data to update the index 22 of metadata with the updated metadata and to transmit the updated index 22 to the second device 12. The third device 20 is configured to transmit the updated index to any other device with access to the index 22 stored in the third device 20. The third device 20 then sends the operated data in the requested format to the clipboard monitor 18 of the second device 12 which copies the operated data to the clipboard 16. The append and paste operations terminate thereafter until a new request is made by the user.

Referring to FIGS. 2A, 2B and 2C of the accompanying drawings, the operation of the system described above will now be explained further.

If the state of the requested format is not empty (e.g., a valid GUID), the data is known to not have been cached at the data management module 21 on the third device 20. In such a case, the clipboard monitor 18 is configured to determine the address (e.g., IP address) of the source of the data (the first device 2 in the example described herein) from the index file. The clipboard monitor 18 is then configured to send a request to the first device 2 based on the address. In response to the request, the clipboard monitor 10 of the first device 2 is configured to retrieve the data from the clipboard 8 in the requested format, and then send the data in the requested format to the third device 20. After the data is received at the third device 20, the data management module 21 is configured to store the data in the cache of the third device 20 and update the index file accordingly. For example, the data management module 21 is configured to change the state for the requested format from a valid GUID to empty (or all zeros) in the index file. The data management module 21 is then configured to broadcast the updated index file to those devices that use the index file, including the second device 12.

In some embodiments, the clipboard monitor 18 receives a delayed render request from the clipboard 16 of the second device 12. In response to the delayed render request, the clipboard monitor 18 is configured to send a direct communication message (e.g., a user datagram protocol (UDP) message) to the first device 2 (i.e., the source of the data). The clipboard monitor 18 then waits for a direct acknowledgement from the first device 2 to indicate that the data is ready to read from the third device 20.

In some embodiments, cached data is stored in the native clipboard format in the cache at the data management module 21. For example, text data can be stored in a text format; bitmap data can be stored in a binary format; etc. In some embodiments, no additional processing or translation is required on the cached data. In some other embodiments, cached data can be processed or translated. For example, to enable cut and paste of files (e.g., in a format of “FileDrop”), the path names stored in the associated format (e.g., the format of “FileDrop”) are required to be converted from local paths to shared paths pointing to the shared data store, such that the files can be accessible to a remote device that requests those files. Additionally, the file data can be copied from the local machine to the shared areas for the files whose file paths are converted from local paths to shared paths.

After the clipboard monitor 18 of the second device 12 receives a message indicating the requested data is ready for read at the third device 20, the clipboard monitor 18 is configured to read the data in the requested format from the data management module 21 of the third device 20. In some embodiments, the clipboard monitor 18 is configured to read the updated index file from the data management module 21 as well. The clipboard monitor 18 is then configured to copy the data in the requested format to the clipboard 16, which can paste the data in the requested format when the data is ready.

In some embodiments, when a new clipboard monitor joins the group of clipboard monitors (e.g., a new device is coupled to the third device 20 and thus included in the system), an available format recorded in the index file can be added as a deferred render marker to a clipboard associated with the new clipboard monitor (e.g., in the new device), even if the index file indicates that data is stored in the cache in that available format. In such embodiments, the data in the available format is marked as deferred and will only be processed if a user requests the data in the available format via an explicit paste command.

In some embodiments, the data to be pasted can be stored in and retrieved from a last-in, first-out (LIFO) cache or a pick list based on a history cache at the third device 20. In some other embodiments, the data can be stored in a first-in, first-out (FIFO) cache or any other type of cache at the third device 20.

While shown and described above with respect to FIG. 1 as the third device 20 being a separate device from the first device 2 and the second device 12, in other embodiments, the functionality of the third device 20 including the data management module 21, the index file and the cache can be incorporated into either of the first device 2 or the second device 12.

While shown and described with respect to FIG. 1 as the third device 20 being coupled to two devices (i.e., the first device 2 and the second device 12) running clipboard monitors, in other embodiments, the system can include any number of devices (real or virtual) operatively coupled to a shared device (e.g., the third device 20) and collectively configured to perform the acquire and paste operation as described herein.

It will be appreciated that connectivity between the first, second and third devices, although described as being over the Internet, could be any suitable network connection between the three remote devices. Furthermore, although described above as a separate device, the functionality of the third device could be incorporated into either of the first or second devices.

It will also be appreciated that although described by an embodiment with a clipboard monitor or a data management module configured to perform an append operation, any other modules on any devices can perform the same functionality. Furthermore, although only an append operation is described above, other operations such as a remove operation or any other form of data manipulation wherein a comparison of a pair of data can be used may be performed using the devices, clipboard monitors, data management modules, system or method described herein. Together, the append and other operations are referred to as “amendment” operations.

Advantages of the system described herein includes that data is only transferred on demand, existing clipboard logic is used, clipboard data can be cached and persisted independent of the state of the user's machine and clipboards can be shared between any number of local, virtual and remote machines.

Although a few embodiments have been shown and described, it will be appreciated by those skilled in the art that various changes and modifications might be made without departing from the scope of the invention, as defined in the appended claims.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is only one example of a generic series of equivalent or similar features.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals (e.g., a propagating electromagnetic wave carrying information on a transmission medium such as space or a cable). The media and computer code (also referred to herein as code) may be those designed and constructed for the specific purpose or purposes. Examples of non-transitory computer-readable media include, but are not limited to: magnetic storage media such as hard disks, optical storage media such as Compact Disc/Digital Video Discs (CD/DVDs), Compact Disc-Read Only Memories (CD-ROMs), magneto-optical storage media such as optical disks, carrier wave signal processing modules, and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages and/or other development tools.

While various embodiments have been described above, it should be understood that they have been presented by way of example only, and not limitation, and as such, various changes in form and/or detail may be made. Any portion of the apparatus and/or methods described herein may be combined in any suitable combination, unless explicitly expressed otherwise. Where methods and/or schematics described above indicate certain events and/or flow patterns occurring in certain order, the ordering of certain events and/or flow patterns may be modified. Additionally certain events may be performed concurrently in parallel processes when possible, as well as performed sequentially.

1-9. (canceled)

10. An apparatus, comprising:
a clipboard monitor at a first device configured to be operatively coupled to a data management module, the clipboard monitor configured to receive, from the data management module, metadata associated with data acquired in an acquire operation at a second device, the clipboard monitor configured to detect a paste operation associated with the data at the second device, the clipboard monitor configured to send a request for the data to the second device based on the metadata associated with the data, the clipboard monitor configured to receive the data in response to sending the request.

11. The apparatus of claim 10, wherein the clipboard monitor is configured to determine, based on the metadata, that the data is stored in a cache at the data management module, the clipboard monitor configured to receive the data stored in the cache.

12. The apparatus of claim 10, wherein the clipboard monitor is configured to determine, based on the metadata, that the data is not stored in a cache at the data management module, the clipboard monitor configured to receive the data from the second device via the data management module.

13. The apparatus of claim 10, wherein the data management module is at a third device different from the first device.

14. The apparatus of claim 10, wherein the metadata identifies a format associated with the data, the clipboard monitor configured to receive the data in a format requested in the request.

15. The apparatus of claim 10, wherein the metadata identifies a source of the data, the clipboard monitor configured to send the request for the data to the second device based on the source of the data.

16. The apparatus of claim 10, wherein the metadata includes an Internet Protocol (IP) address identifying a source of the data, the clipboard monitor configured to send the request for the data to the second device based on the IP address.

17. The apparatus of claim 10, wherein the metadata identifies an identifying code uniquely associated with a source of the data, the clipboard monitor configured to send the request for the data to the second device based on the identifying code.

18. The apparatus of claim 10, wherein the clipboard monitor is configured to send location information associated with the clipboard monitor to the data management module during initialization of the clipboard monitor.

19. The apparatus of claim 10, wherein the clipboard monitor is configured to amend the data in the clipboard of the first device by:
monitoring any new data being added to the clipboard;
determining whether a modifier is active or not wherein the modifier is active if a modifier input is received prior to or during the paste operation;
if the modifier is active, storing the new data to a cache or a storage medium;
retrieving previous data added to the clipboard from a cache or a storage medium on the second device;
performing an amendment operation on the previous data and the new data to create an operated data as part of the paste operation;
storing the operated data to the cache or the storage medium; and
adding the operated data to the clipboard.

20. (canceled)

21. The apparatus of claim 19, wherein the clipboard monitor is also configured to:
determine if the new data includes an operation marker, wherein the operation marker indicates whether an operation has been performed on the new data or not;
if the operation marker indicates the operation has not been performed on the new data, proceed to the next step in amending the data in the clipboard of the second device; and
add the operation marker to the operated data after the amendment operation.

22-25. (canceled)

26. An apparatus, comprising:
a data management module implemented in one of a memory or a processing device, the data management module configured to be operatively coupled to a first clipboard monitor at a first device and a second clipboard monitor at a second device, the data management module configured to receive, from the first clipboard monitor, metadata associated with data acquired in an acquire operation at the first device, the data management module configured to update an index of metadata to produce an updated index of metadata in response to receiving the metadata, the data management module configured to send the updated index of metadata to the second clipboard monitor.

27. The apparatus of claim 26, wherein the data management module is configured to receive the data acquired in the acquire operation from the first clipboard monitor, the data management module configured to store the data in a cache, the data management module configured to send the data stored in the cache to the second clipboard monitor in response to a request associated with a paste operation at the second device.

28. (canceled)

29. The apparatus of claim 26, wherein the metadata includes an identifying code uniquely associated with a source of the data.

30. The apparatus of claim 26, wherein the data management module is configured to receive location information associated with the first clipboard monitor during initialization of the first clipboard monitor, the data management module configured to receive location information associated with the second clipboard monitor during initialization of the second clipboard monitor.

31. The apparatus of claim 26, wherein the metadata includes metadata indicating the data is stored in a cache.

32. The apparatus of claim 26, wherein the data management module is also configured to perform an amendment operation by:
when a request from the second device is received, determining whether a modifier is active on the second device from the request, wherein the modifier on the second device is active if a modifier input is received prior to or during the paste operation;
retrieving previous data requested by the second device from cached previously requested data or using the index of metadata;
performing an amendment operation on the previously requested data and the requested data to create an operated data as part of the paste operation;
storing the operated data to the cache;
updating the metadata of the operated data and the index of metadata; and
transmitting the updated index to the first and second devices.

33. The apparatus of claim 32, wherein the data management module is also configured to provide the operated data to the second device when the cached data of the requested and the previously requested data become available.

34-37. (canceled)

38. A method, comprising:
receiving from a first clipboard monitor associated with a first device metadata associated with data acquired in an acquire operation at the first device;
in response to receiving the metadata, updating an index of metadata to produce an updated index of metadata; and
sending the updated index of metadata to a second clipboard monitor associated with a second device.

39. The method of claim 38, further comprising:
receiving from the first device the data acquired in the acquire operation;
storing in a cache the data acquired in the acquire operation; and
in response to a request associated with a paste operation from the second device, sending to the second device the data stored in cache.

40. (canceled)

41. The method of claim 38, wherein the metadata includes an identifying code uniquely associated with a source of the data.

42. The method of claim 38, further comprising:
receiving from the first device location information associated with the first clipboard monitor during initialization of the first clipboard monitor; and
receiving from the second device location information associated with the second clipboard monitor during initialization of the second clipboard monitor.

43. The method of claim 38, wherein the metadata includes metadata indicating the data is stored in a cache.

44. The method of claim 38 further comprising the steps of:
the first clipboard monitor obtaining metadata regarding the data acquired in the acquire operation, transferring the acquired metadata to a third device and upon request providing the data associated with the metadata;
the second clipboard monitor detecting a paste operation for a given data item, sending a request for data associated with the requested paste operation;
the second device receiving the data associated with the paste request; and
a third device including a data management module configured to maintain and manage an index of metadata of data that has been subjected to the acquire operation on the first device, wherein the third device transmits the index of metadata to the second device and the first clipboard monitor provides the data to the third device.

45-59. (canceled)
